(19) United States
(12) Patent Application Publication
(10) Pub. No.: US 2023/0109433 A1
(43) Pub. Date: Apr. 6, 2023

(54) TEST SUPPORT METHOD AND INFORMATION PROCESSING APPARATUS

(71) Applicant: FUJITSU LIMITED, Kawasaki-shi (JP)

(72) Inventor: Hiroshi TANAKA, Ota (JP)

(73) Assignee: FUJITSU LIMITED, Kawasaki-shi, Kanagawa (JP)

(21) Appl. No.: 17/879,407

(22) Filed: Aug. 2, 2022

(30) Foreign Application Priority Data
Oct. 6, 2021 (JP) 2021-164476

(51) Int. Cl. G06F 11/36

(52) U.S. Cl. CPC G06F 11/3688; G06F 11/3684

(57) ABSTRACT

A non-transitory computer-readable recording medium stores a program for causing a computer to execute a process that includes acquiring first information indicating a difference between display elements in a first screen of first software before a test operation indicated by a test case is performed for the first screen and display elements in a second screen of the first software after the test operation is performed for the first screen, acquiring second information indicating a difference between display elements in a third screen of second software before the test operation is performed for the third screen and display elements in a fourth screen of the second software after the test operation is performed for the third screen, the second software being generated by updating the first software, and determining whether there is compatibility of the test case between the first and second software based on the first and second information.

### CROSS-REFERENCE TO RELATED APPLICATION

This application is based upon and claims the benefit of priority of the prior Japanese Patent Application No, 2021-164476, filed on Oct. 6, 2021, the entire contents of which are incorporated herein by reference.

### FIELD

The embodiments discussed herein are related to a test support method and an information processing apparatus.

### BACKGROUND

In development of application software (hereinafter simply referred to as an “app”) using a graphical user interface (GUI), for example, predetermined input is performed on a screen for checking the behavior of an app, and a work of verifying whether the app behaves correctly based on a change in display content of the screen is performed. Such behavior verification is repeatedly performed each time an app is modified. A web app is an example of the app using a GUI.

It takes a lot of trouble to manually perform the input operation for behavior verification each time an app is modified. Accordingly, automatic test software is used that records the operation performed on the screen of an app and automatically executes the same operation by using the recorded information.

For example, a computer that executes the automatic test software records information indicating the operation performed by a user for an app. Information recorded in this manner is referred to as a test case. Based on the recorded test case, the computer reproduces the operation performed by the user and executes processing of the app. The computer acquires the processing result of the app and detects abnormal behavior based on the processing result. The computer outputs an error when abnormal behavior is detected.

Various techniques have been proposed for automation of testing an app. For example, a program test support apparatus has been proposed in which a portion not to be compared is set automatically so that there will be no setting omission and it does not take a lot of trouble, and it is possible to easily recognize that the displayed difference obtained by the comparison is not caused by the specifications of a program to be tested, but is caused by a failure. An influence investigation system has also been proposed in which a change in the form of screen display and the compatibility in behavior between web browsers of different types or versions may be efficiently checked.

Japanese Laid-open Patent Publication No, 2001-282578 and Japanese Laid-open Patent Publication No. 2016-45545 are disclosed as related art.

### SUMMARY

According to an aspect of the embodiments, a non-transitory computer-readable recording medium stores a program for causing a computer to execute a process, the process includes acquiring first difference information that indicates a difference between display elements included in a first screen of first software before a test operation indicated by a test case is performed for the first screen and display elements included in a second screen of the first software after the test operation is performed for the first screen, acquiring second difference information that indicates a difference between display elements included in a third screen of second software before the test operation is performed for the third screen and display elements included in a fourth screen of the second software after the test operation is performed for the third screen, the second software being generated by updating the first software, and determining whether there is compatibility of the test case between the first software and the second software based on the first difference information and the second difference information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a test support method;

FIG. 2 is a diagram illustrating an example of a system configuration according to a second embodiment;

FIG. 3 is a diagram illustrating an example of hardware of a terminal;

FIG. 4 is a block diagram illustrating an example of functions of a terminal and a server;

FIG. 5 is a diagram describing the basic processing performed by a capture replay-type test tool;

FIG. 6 is a diagram illustrating an example of behavior verification based on a test case;

FIG. 7 is a diagram lustrating an example of a regression test;

FIG. 8 is a diagram illustrating an example of format change that causes an error in a regression test;

FIG. 9 is a diagram illustrating an example of the incompatibility of a test case;

FIG. 10 is a diagram illustrating an example of two errors having different causes;

FIG. 11 is a diagram illustrating an example of a method of designating an operation target;

FIG. 12 is a diagram illustrating an example of a method of detecting the incompatibility of a test case;

FIG. 13 is a diagram illustrating an example of page difference data;

FIG. 14 is a diagram illustrating an example of a behavior verification function of an automatic test unit;

FIG. 15 is a flowchart illustrating an example of the procedure of behavior verification processing;

FIG. 16 is a flowchart illustrating an example of a procedure of acquisition processing of page difference data for an old version;

FIG. 17 is a diagram illustrating an example of page data saving processing;

FIG. 18 is a flowchart illustrating an example of a procedure of difference detection processing of page data;

FIG. 19 is a flowchart illustrating an example of a procedure of verification processing for a new version;

FIG. 20 is a flowchart illustrating an example of a procedure of test case incompatibility determination processing;

FIG. 21 is a diagram illustrating an example of a case in which neither the incompatibility of a test case nor a failure in a web app is detected;

FIG. 22 is a diagram illustrating an example of a case in which the incompatibility of a test case is detected; and

FIG. 23 is a diagram illustrating an example of a case in which a failure is detected in a web app.

### DESCRIPTION OF EMBODIMENTS

In many cases, behavior verification of a modified app may be performed by reusing a test case that has been used for the behavior verification of the app before modification. However, there are cases in which a test case is unable to be reused. For example, in some cases, a computer that executes a test is unable to find a display element (text input area, button, or the like) to be set as an operation target in a test case in a modified app. In such case, the test case does not behave correctly and an error occurs. A situation in which a test case that has been used for behavior verification of an app before modification is unable to be appropriately used for behavior verification of the app after modification as described above is hereafter referred to as the “incompatibility of a test case”.

In the related art, it is not possible to determine whether an error that has occurred in behavior verification of an app using a test case is caused by the incompatibility of a test case or a failure in the app. For this reason, in a case where a test case is incompatible before and after modification of an app, when behavior verification of the modified app is performed using the test case that has been used in the app before modification, an error is reported even when there is no failure in the modified app. When an error is reported, the person in charge of testing has to identify the cause of the error with extra workload.

Accordingly, a technique of detecting that the cause of an error that has occurred in behavior verification is the incompatibility of a test case is desired. For example, if an error caused by the incompatibility of a test case may be detected, the workload of a user for developing an app may be reduced by reporting to the user only an error caused by a failure in the app.

Hereinafter, embodiments will be described with reference to the drawings. Each of the embodiments may be implemented by combining a plurality of embodiments within a range without contradiction.

### First Embodiment

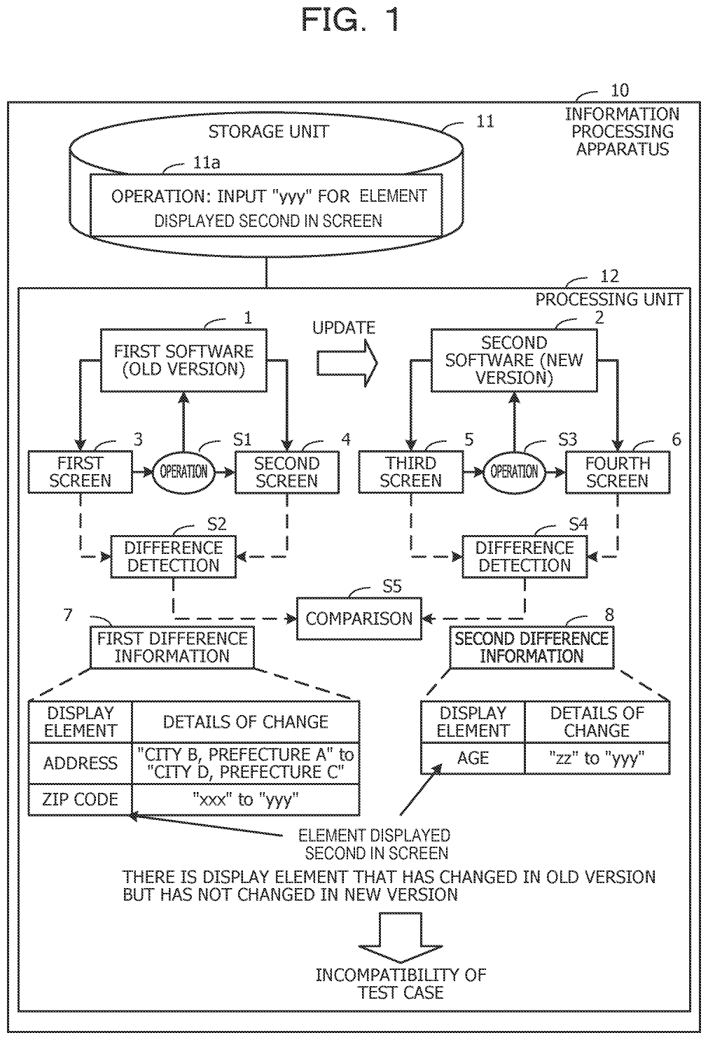

As a first embodiment, a test support method for determining whether there is compatibility of a test case before and after software update will be described with reference to FIG. 1.

FIG. 1 is a diagram illustrating an example of the test support method. FIG. 1 illustrates an information processing apparatus 10 that implements the test support method. For example, the information processing apparatus 10 may implement the test support method by executing a test support program.

The information processing apparatus 10 includes a storage unit 11 and a processing unit 12 in order to implement the test support method. For example, the storage unit 11 is a storage device or a memory included in the information processing apparatus 10, For example, the processing unit 12 is an arithmetic circuit or a processor included in the information processing apparatus 10.

The storage unit 11 stores a test case 11a. The test case 11a is data indicating an operation for testing first software 1 or second software 2. The second software 2 is software generated by updating the first software 1. For example, the first software 1 is software of an old version for the second software 2. Conversely, the second software 2 is software of a new version for the first software 1.

For example, the operation for testing is an operation for verifying whether expected processing is executed in response to the operation for a predetermined display element of a predetermined screen of the first software 1 or the second software 2. For example, the test case 11a may define, in association with the operation for testing, the correct contents of the updated screen to be obtained when the operation is executed.

The processing unit 12 may execute the first software 1 and the second software 2. The processing unit 12 acquires first difference information 7 and second difference information 8 based on the test case 11a. The first difference information 7 is information indicating a difference between the display elements included in a first screen 3 before a predetermined operation is performed for the first software 1 and the display elements included in a second screen 4 of the first software 1 after the predetermined operation is performed for the first screen 3. The second difference information 8 is information indicating a difference between the display elements included in a third screen 5 before a predetermined operation is performed for the second software 2 and the display elements included in a fourth screen 6 of the second software 2 after the predetermined operation is performed for the third screen 5.

The processing unit 12 determines whether the test case 11a has compatibility between the first software 1 and the second software 2 based on the first difference information 7 and the second difference information 8.

For example, the processing unit 12 acquires the first difference information 7 indicating first display elements whose values have been changed when the screen transitioned from the first screen 3 to the second screen 4. The processing unit 12 acquires the second difference information 8 indicating a second display element whose value has been changed when the screen transitioned from the third screen 5 to the fourth screen 6. In the processing of determining whether there is compatibility of the test case 11a, the processing unit 12 determines that there is not compatibility of the test case 11a when there is no corresponding second display element for at least one of the first display elements. The position of a display element in a tree structure and the name of a display element may be changed by software update.

For example, the second display element corresponding to a first display element is a second display element whose position in a tree structure represented as the data structure of a screen is the same as that of the first display element. A second display element to which the same name as the name given to a first display element is given may be set as the second display element corresponding to the first display element.

In the example of FIG. 1, the operation of inputting “yyy” for the element displayed second in a screen is indicated in the test case 11a. In this example, the operation target is designated by the order of display elements in the data structure representing a screen.

For example, the processing unit 12 saves information indicating the first screen 3 before any operation is performed for the first software 1. Next, the processing unit 12 performs the operation indicated in the test case 11a for the first screen 3 (step S1), The processing unit 12 saves information indicating the second screen 4. The processing unit 12 detects the difference in display elements between the first screen 3 and the second screen 4, and acquires the first difference information 7 (step S2). For example, the first difference information 7 indicates the details of change for display elements (first display elements) of which content has been changed.

In the example of FIG. 1, the first difference information 7 includes, as the first display elements, a display element displaying “address” and a display element displaying “zip code”. The display element displaying “zip code” is the element displayed second in the first screen 3, and is the display element to be operated in the test case 11a.

For example, the processing unit 12 saves information indicating the third screen 5 before any operation is performed for the second software 2. Next, the processing unit 12 performs the operation indicated in the test case 11a for the third screen 5 (step S3). The processing unit 12 saves information indicating the fourth screen 6. The processing unit 12 detects the difference in display elements between the third screen 5 and the fourth screen 6, and acquires the second difference information 8 (step S4), For example, the second difference information 8 indicates the details of change for a display element (second display element) of which content has been changed.

In the example of FIG. 1, the second difference information 8 includes a display element displaying “age” as the second display element. The display element displaying “age” is the element displayed second in the third screen 5, and is the display element to be operated in the test case 11a.

The processing unit 12 compares the first difference information 7 with the second difference information 8 (step S5). It may be considered that both the display element of the operation target in the first screen 3 (zip code) and the display element of the operation target in the third screen 5 (age) are operation targets and have a correspondence relationship. Accordingly, in the example of FIG. 1, a corresponding second display element is included in the second difference information 8 for the display element displaying zip code out of the first display elements included in the first difference information 7, On the other hand, since there is only one second display element in the second difference information 8, a corresponding second display element is not included in the second difference information 8 for the first display element displaying address. For example, there is a display element that has changed in the first software 1 of an old version but has not changed in the second software 2 of a new version. In this case, the processing unit 12 determines that the test case 11a is incompatible.

As described above, incompatibility of the test case 11a may be detected. In a case where the test case 11a does not have compatibility, even if an error occurs when testing the second software 2 based on the test case 11a, it may not be said that there is a failure in the second software 2. Accordingly, when an error occurs due to the incompatibility of the test case 11a, a user modifies the test case 11a, creates the test case 11a again, or takes other measures. For example, the user may quickly deal with an error when the error occurs, and the efficiency of behavior verification is improved.

The processing unit 12 may determine whether there is a failure in the second software 2 after determining that the test case 11a has compatibility. For example, the processing unit 12 determines that the test case 11a has compatibility when there is a corresponding second display element for all of the first display elements. When it is determined that the test case 11a has compatibility, the processing unit 12 executes the processing of determining whether there is a failure in the second software 2.

Accordingly, the processing of determining whether there is a failure in the second software 2 may be suppressed in a case where the test case 11a does not have compatibility. As a result, behavior verification of the second software 2 may be efficiently performed.

The processing unit 12 may detect a failure in the second software 2 by using the first difference information 7 and the second difference information 8. For example, the processing unit 12 acquires the first difference information 7 including the changed values of the first display elements. The processing unit 12 acquires the second difference information 8 including the changed value of the second display element. The processing unit 12 determines whether there is a failure in the second software 2 based on a result of comparison between the changed value of a first display element and the changed value of the second display element corresponding to the first display element. For example, when the changed value of a first display element and the changed value of the second display element corresponding to the first display element are distinct from each other, the processing unit 12 determines that there is a failure in the second software 2.

As described above, whether there is a failure in the second software 2 may be determined based on the first difference information 7 and the second difference information 8. Accordingly, a failure may be detected without performing such determination processing as to determine whether the changed value is within a predetermined appropriate range. As a result, a failure may be efficiently detected. The reliability of detecting a failure in the second software 2 may be improved.

### Second Embodiment

A second embodiment is a computer system in which work efficiency of behavior verification performed when a web app is modified is improved.

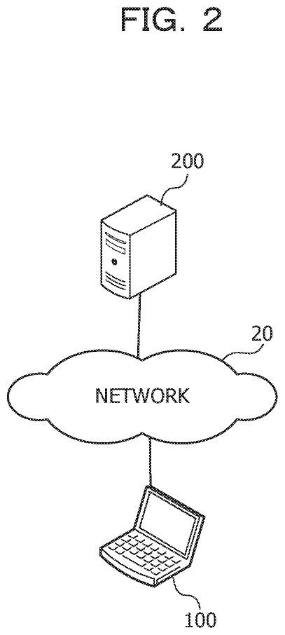

FIG. 2 is a diagram illustrating an example of a system configuration according to the second embodiment. In the example of FIG. 2, a terminal 100 and a server 200 are coupled via a network 20. The terminal 100 is a computer used by a user who performs behavior verification of a web app. The server 200 is a computer that executes a web app.

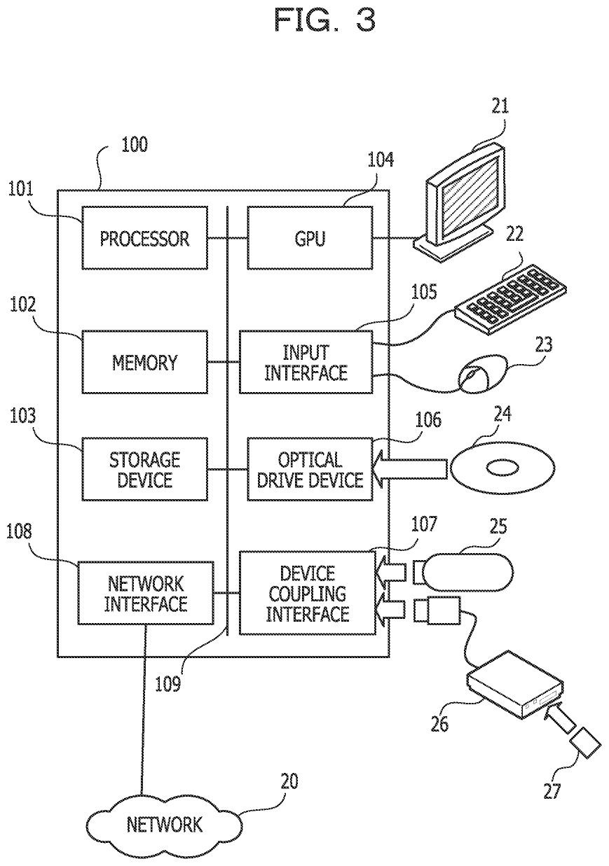

FIG. 3 is a diagram illustrating an example of hardware of the terminal. The terminal 100 is entirely controlled by a processor 101. A memory 102 and a plurality of peripheral devices are coupled to the processor 101 via a bus 109. The processor 101 may be a multiprocessor. For example, the processor 101 is a central processing unit (CPU), a microprocessor unit (MPU), or a digital signal processor (DSP). At least some of the functions implemented by the processor 101 executing a program may be implemented by an electronic circuit such as an application-specific integrated circuit (ASIC) or a programmable logic device (PLD).

The memory 102 is used as a main memory of the terminal 100. The memory 102 temporarily stores at least part of an operating system (OS) program or an application program to be executed by the processor 101. The memory 102 stores various data to be used for the processing by the processor 101. For example, a volatile semiconductor memory such as a random-access memory (RAM) is used as the memory 102.

The peripheral devices coupled to the bus 109 include a storage device 103, a graphics processing unit (GPU) 104, an input interface 105, an optical drive device 106, a device coupling interface 107, and a network interface 108.

The storage device 103 electrically or magnetically writes and reads data to and from a built-in recording medium. The storage device 103 is used as an auxiliary memory of the terminal 100. The storage device 103 stores an OS program, an application program, and various data. For example, a hard disk drive (HDD) or a solid-state drive (SSD) may be used as the storage device 103.

The GPU 104 is an arithmetic device that performs image processing, and is also referred to as a graphic controller. A monitor 21 is coupled to the GPU 104. The GPU 104 displays images on a screen of the monitor 21 in accordance with an instruction from the processor 101. The monitor 21 is a display device using organic electro luminescence (EL), a liquid crystal display device, or the like.

A keyboard 22 and a mouse 23 are coupled to the input interface 105. The input interface 105 transmits signals sent from the keyboard 22 and the mouse 23 to the processor 101. The mouse 23 is an example of a pointing device, and other pointing devices may be used, Other pointing devices include a touch panel, a tablet, a touch pad, a track ball, and the like.

The optical drive device 106 reads data recorded in an optical disc 24 or writes data to the optical disc 24 by using laser light or the like. The optical disc 24 is a portable-type recording medium in which data is recorded such that the data is readable through reflection of light. The optical disc 24 is a Digital Versatile Disc (DVD), a DVD-RAM, a compact disc read-only memory (CD-ROM), a CD-recordable (CD-R), a CD-rewritable (CD-RW), or the like.

The device coupling interface 107 is a communication interface for coupling a peripheral device to the terminal 100. For example, a memory device 25 and a memory reader and writer 26 may be coupled to the device coupling interface 107, The memory device 25 is a recording medium in which the function of communication with the device coupling interface 107 is provided. The memory reader and writer 26 is a device that writes data to a memory card 27 or reads data from the memory card 27, The memory card 27 is a card-type recording medium.

The network interface 108 is coupled to the network 20. The network interface 108 transmits and receives data to and from another computer or communication device via the network 20. For example, the network interface 108 is a wired communication interface that is coupled to a wired communication device such as a switch or a router by a cable. The network interface 108 may be a wireless communication interface that is coupled to and communicates with a wireless communication device such as a base station or an access point by radio waves.

The terminal 100 may implement the processing functions of the second embodiment by the above-described hardware. The information processing apparatus 10 described in the first embodiment may also be implemented by hardware similar to that of the terminal 100 illustrated in FIG. 3.

For example, the terminal 100 implements the processing functions of the second embodiment by executing a program recorded in a computer-readable recording medium. The program in which the details of processing to be executed by the terminal 100 are described may be recorded in various recording media. For example, the program to be executed by the terminal 100 may be stored in the storage device 103. The processor 101 loads at least part of the program in the storage device 103 to the memory 102, and executes the program. The program to be executed by the terminal 100 may be recorded on a portable-type recording medium such as the optical disc 24, the memory device 25, or the memory card 27. For example, the program stored in a portable-type recording medium may be executed after being installed in the storage device 103 by the control from the processor 101, The processor 101 may read the program directly from a portable-type recording medium and execute the program.

Next, functions of the terminal 100 and the server 200 for behavior verification of a web app will be described.

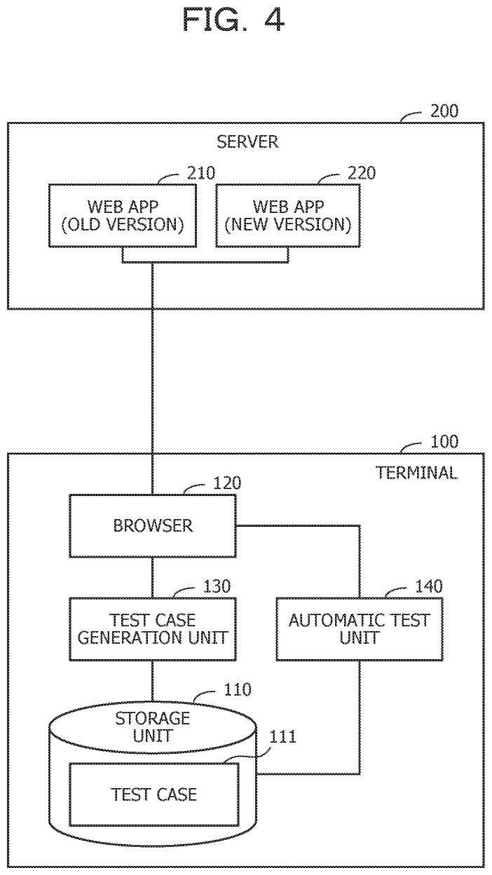

FIG. 4 is a block diagram illustrating an example of functions of the terminal and the server. A web app 210 of an old version and a web app 220 of a new version are implemented in the server 200. Each of the web apps 210 and 220 is a function implemented by the processor of the server 200 executing a corresponding program. For example, the program corresponding to the web app 220 of a new version is created by modifying the program of the web app 210 of an old version. The web app 210 is an example of the first software 1 in the first embodiment. The web app 220 is an example of the second software 2 in the first embodiment.

Although the web app 210 of an old version and the web app 220 of a new version are simultaneously implemented in the server 200 in the example of FIG. 4, the web app 220 of a new version does not have to be implemented yet at the time of executing processing such as detection of a change in the contents of a page of the web app 210 of an old version. The web app 210 of an old version may be deleted from the server 200 before behavior verification of the web app 220 of a new version is executed.

The terminal 100 includes a storage unit 110, a browser 120, a test case generation unit 130, and an automatic test unit 140. A test case 111 is stored in the storage unit 110. The test case 111 is data indicating the details of a test to be performed on the web apps 210 and 220.

The browser 120 accesses the web apps 210 and 220 by using a World Wide Web (WWW), and displays a web page acquired from the web apps 210 and 220, For example, when acquiring data in a HyperText Markup Language (HTML) format from the web apps 210 and 220, the browser 120 performs syntax analysis on the data and generates a page image corresponding to the analysis result.

The test case generation unit 130 generates the test case 111 for behavior verification of the web apps 210 and 220. For example, the test case generation unit 130 acquires details of operation performed for the web app 210 of an old version displaying the web page acquired from the web app 210. The test case generation unit 130 generates the test case 111 by adding, on an operation-by-operation basis, verification processing of determining whether the content of the web page after the operation is correct. For example, verification processing is processing of determining whether a zip code and an address displayed in a web page are consistent with each other. For example, processing of determining whether an input character or numerical value is within a range allowed by a text input area is added as verification processing. For example, details of such verification processing is designated by a user.

The automatic test unit 140 performs behavior verification of the web apps 210 and 220 by performing input operation for the browser 120 based on the test case 111. For example, the automatic test unit 140 performs predetermined input to a display element in a web screen displayed by the browser 120, and acquires web page data of the web screen that has been updated in response to the input. The automatic test unit 140 verifies the contents indicated in the acquired web page data, and outputs an error when the contents are not correct.

The lines coupling the elements illustrated in FIG. 4 indicate some communication paths, and a communication path other than the illustrated communication paths may be set. For example, the function of each element illustrated in FIG. 4 may be implemented by causing a computer to execute a program module corresponding to the element.

For example, software for implementing the function including the test case generation unit 130 and the automatic test unit 140 included in the terminal 100 is referred to as a capture replay-type test tool.

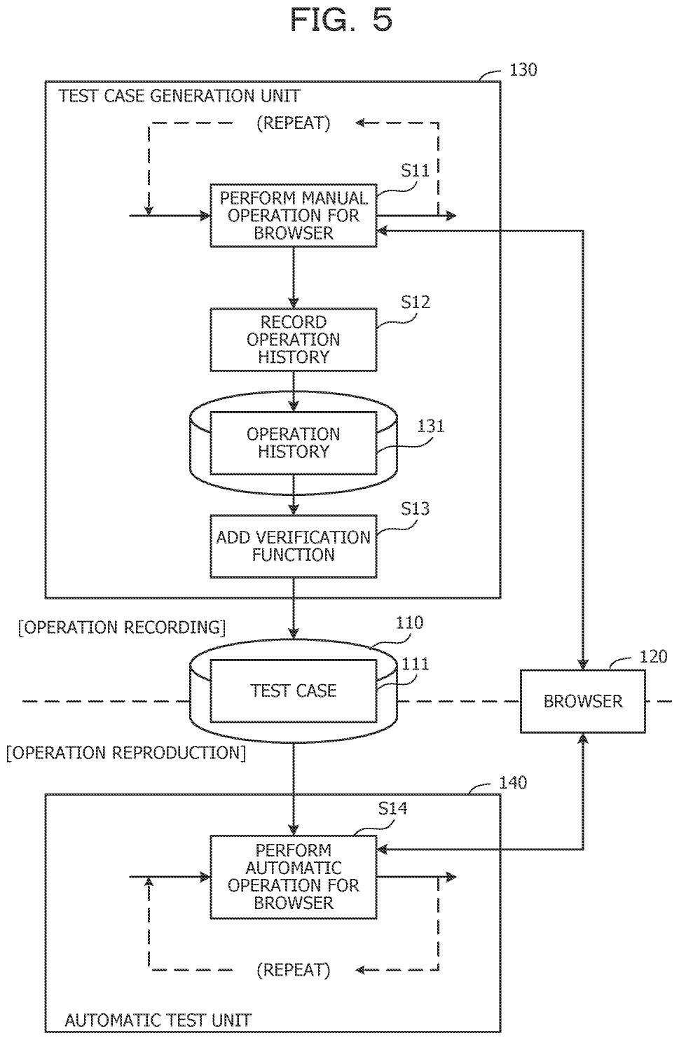

FIG. 5 is a diagram describing basic processing performed by the capture replay-type test tool. The processing to be performed by the capture replay-type test tool is divided into processing of recording the operation performed by the test case generation unit 130 for the browser 120 and operation reproduction processing performed by the automatic test unit 140.

For example, when a user performs input to the browser 120 by a manual operation, the test case generation unit 130 acquires information indicating the details of the manual operation performed by the user (step S11). The manual operation by the user is repeatedly performed, and the test case generation unit 130 acquires information indicating the details of the manual operation each time the manual operation is performed.

The test case generation unit 130 records, as an operation history 131, the acquired series of information indicating the details of the manual operation in the memory 102 or the storage device 103 (step S12). The test case generation unit 130 generates the test case 111 by adding the verification function to the operation history 131 (step S13). The test case generation unit 130 stores the generated test case 111 in the storage unit 110.

In the operation reproduction processing, the automatic test unit 140 performs automatic operation for the browser 120 based on the operation history included in the test case 111 (step S14). At this time, the browser 120 transmits information corresponding to the operation to the web app of behavior verification target, and acquires web page data corresponding to the processing result from the web app. Based on the verification function included in the test case 111, the automatic test unit 140 verifies whether information included in the web page data acquired by the browser 120 is incorrect. If the information is incorrect, the automatic test unit 140 outputs an error.

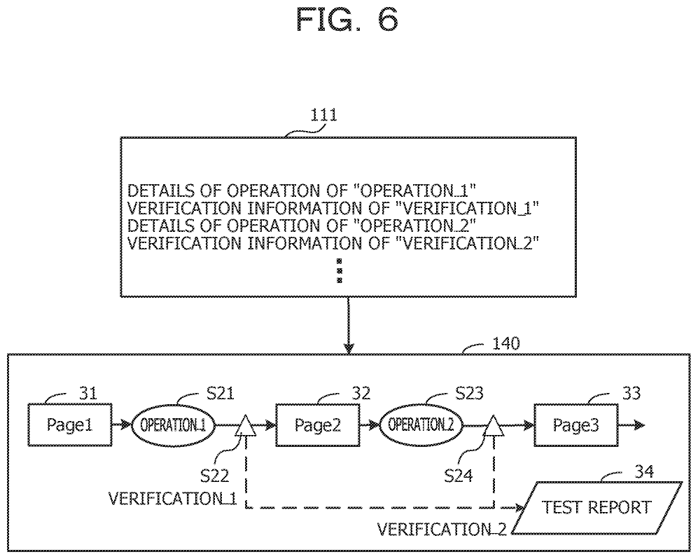

FIG. 6 is a diagram illustrating an example of behavior verification based on a test case. In the test case 111, details of operation recorded as an operation history and verification information for verifying the processing result corresponding to the operation are alternately indicated. For example, details of operation include information designating a display element of an operation target in a web page (for example, where the element is placed in the display sequence) and information indicating the operation to be performed for the display element. For example, the operation to be performed for the display element is pressing a button, inputting a character string, or the like. For example, verification information includes information designating a display element of a verification target and information indicating the operation allowed for the display element. For example, in a case where the display element is a text box, information such as the range of numerical value and the number of characters that may be input to the text box is included in the verification information.

The automatic test unit 140 reproduces the operation indicated in the test case 111 in order from the top. For example, the automatic test unit 140 performs an operation for the browser 120 on which the first web page 31 (Page1) is displayed in accordance with the details of the operation of “operation_1” (step S21). The operation target is a display element displayed on the web page 31. After the screen of the browser 120 is updated in response to the performed operation, the automatic test unit 140 acquires the data of the second web page 32 (Page2) and verifies whether information is incorrect in accordance with the verification information of “verification_1” (step S22).

After that, the automatic test unit 140 performs an operation for the browser 120 on which the web page 32 is displayed in accordance with the details of operation of “operation_2” (step S23). After the screen of the browser 120 is updated in response to the performed operation, the automatic test unit 140 acquires the data of the third web page 33 (Page3) and verifies whether information is incorrect in accordance with the verification information of “verification_2” (step S24). The automatic test unit 140 outputs the verification result as a test report 34.

As described above, behavior verification of the web apps 210 and 220 communicating with the browser 120 may be performed by the test case generation unit 130 recording the operation performed for a web page and the automatic test unit 140 reproducing the operation. The version of a web app used when the test case 111 is generated may be different from the version of a web app subjected to behavior verification. For example, in a case where a regression test is performed, behavior verification is performed by applying the same test case 111 to each of the web apps 210 and 220 of different versions.

A regression test is a test for checking whether an app that has been operating correctly before modification operates in the same manner after modification, in a method of developing an app stepwise (continuously). The object of a regression test is to check that the same verification result is obtained before and after modification or to detect a distinction in behavior between a new version and an old version assuming that the result of execution in the old version is the correct one.

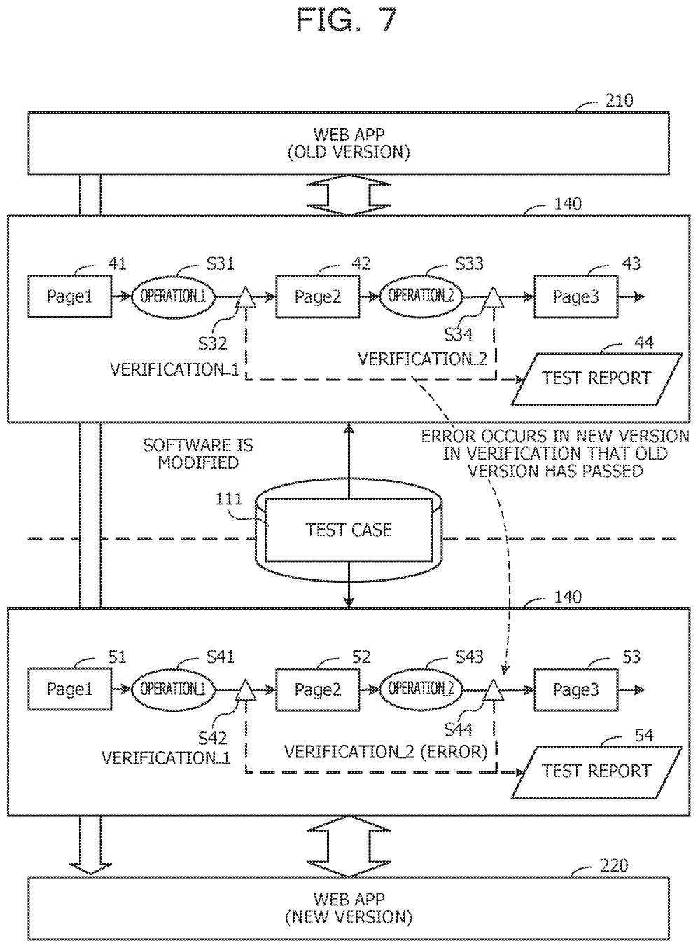

FIG. 7 is a diagram illustrating an example of a regression test. For example, the automatic test unit 140 first operates the browser 120 by using the test case 111, with the web app 210 of an old version as a verification target. For example, the automatic test unit 140 performs operation indicated in the details of operation of “operation_1” for a web page 41 that is based on the data transmitted from the web app 210 (step S31). The automatic test unit 140 performs verification for a web page 42 sent from the web app 210 in response to the operation (step S32). After the verification, the automatic test unit 140 performs operation indicated in the details of operation of “operation_2” for the web page 42 (step S33). The automatic test unit 140 performs verification for a web page 43 sent from the web app 210 in response to the operation (step S34). After the operation and verification indicated in the test case 111 have all ended, the automatic test unit 140 outputs a test report 44 indicating the verification result.

After that, the software of the web app 210 is modified and the web app 220 of a new version is generated. At this time, the automatic test unit 140 first operates the browser 120 by using the test case 111, with the web app 220 of a new version as a verification target. For example, the automatic test unit 140 performs operation indicated in the details of operation of “operation_1” for a web page 51 that is based on the data transmitted from the web app 220 (step S41). The automatic test unit 140 performs verification for a web page 52 sent from the web app 220 in response to the operation (step S42). After the verification, the automatic test unit 140 performs operation indicated in the details of operation of “operation_2” for the web page 52 (step S43). The automatic test unit 140 performs verification for a web page 53 sent from the web app 220 in response to the operation (step S44). After the operation and verification indicated in the test case 111 have all ended, the automatic test unit 140 outputs a test report 54 indicating the verification result.

When behavior verification is performed for each of the web app 210 of an old version and the web app 220 of a new version as described above, there is a possibility that an error occurs in the web app 220 of a new version in the verification that the web app 210 of an old version has passed. In the example of FIG. 7, an error is detected in the verification of step S44. In this case, it may be determined that a failure has occurred in the operation indicated in the details of operation of “operation_2”, which is the immediately preceding operation.

As an example of a case in which an error occurs in a regression test, there is a case in which the position of a display element of an operation target in a web page changes due to the modification of the web app 210, and the automatic test unit 140 performs operation for an incorrect display element.

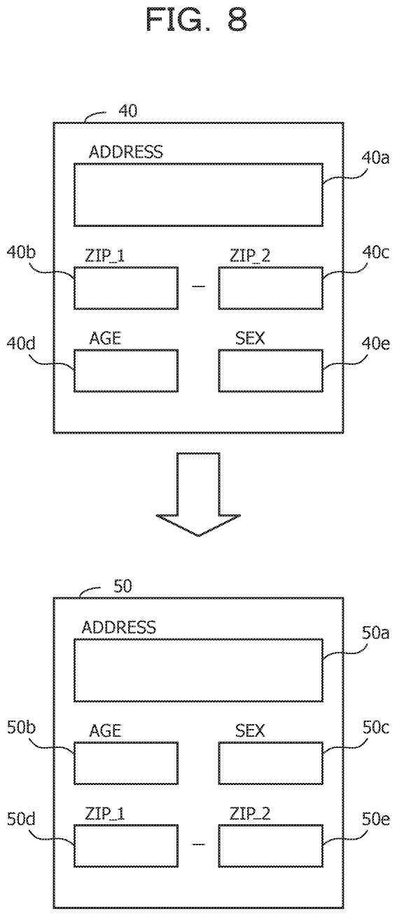

FIG. 8 is a diagram illustrating an example of format change that causes an error in a regression test. Five text boxes 40a to 40e are provided in the web page of a format 40 of the web app 210 of an old version. The text box 40a provided at the uppermost position is an input area for address.

The two text boxes 40b and 40c arranged side by side below the text box 40a are input areas for zip code. The text box 40b on the left side is an input area for the first three digits of a zip code, and the text box 40c on the right side is an input area for the last four digits of a zip code.

The text box 40d provided below the text box 40b is an input area for age. The text box 40e provided on the right side of the text box 40d is an input area for sex.

Similarly to the old version, five text boxes 50a to 50e are provided in the web page of a format 50 of the web app 220 of a new version. The text box 50a provided at the uppermost position is an input area for address.

Of the text boxes 50b and 50c arranged side by side below the text box 50a, the text box 50b on the left side is an input area for age. The text box 50c provided on the right side of the text box 50b is an input area for sex.

The text boxes 50d and 50e arranged side by side below the text box 50b and the text box 50c are input areas for zip code. The text box 50d on the left side is an input area for the first three digits of a zip code, and the text box 50e on the right side is an input area for the last four digits of a zip code.

In the example of FIG. 8, the arrangement of the text boxes serving as input areas for zip code, age, and sex is changed by modifying the web app 210 to the web app 220, Such change of arrangement may cause the incompatibility of a test case.

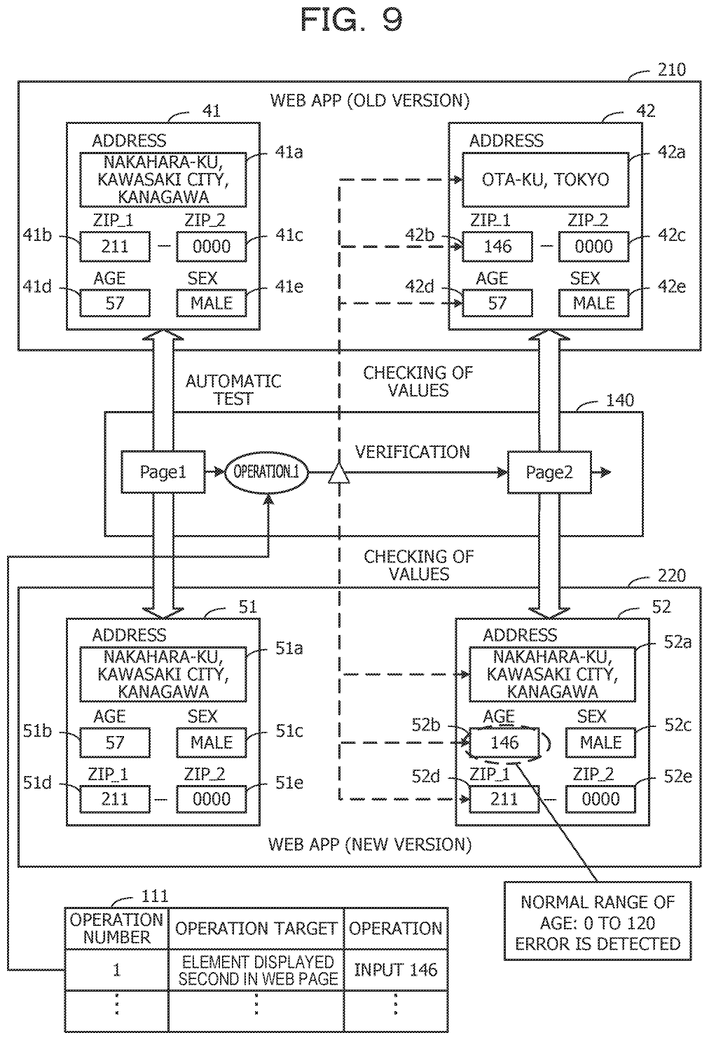

FIG. 9 is a diagram illustrating an example of the incompatibility of a test case. In the example of FIG. 9, an operation target and an operation are set in the test case 111 in association with an operation number. The operation target is information indicating a display element to be operated. The operation is information indicating the operation to be performed for a display element of the operation target. For example, it is indicated that in the operation of operation number “1”, the operation of inputting the number “146” is performed with the element displayed second in a web page as an operation target.

Assuming that the web app 210 is a verification target, the web page 41 before the operation of operation number “1” (operation_1) includes five text boxes 41a to 41e. “Nakahara-ku, Kawasaki City, Kanagawa” is set in the text box 41a. “211” is set in the text box 41b. “0000” is set in the text box 41c. “57” is set in the text box 41d. “male” is set in the text box 41e.

The automatic test unit 140 performs the operation of inputting “146” to the text box 41b corresponding to the element displayed second in the web page 41 in accordance with the test case 111. The web app 210 executes processing in response to the operation of operation number “1”, and the web page to be displayed by the web app 210 is updated to the web page 42. Among five text boxes 42a to 42e included in the web page 42 after the operation, the input value “146” is set in the text box 42b corresponding to the element displayed second in the web page.

The text box 42b is an input area for zip code. In the example of FIG. 9, the web app 210 has a function of automatically setting an address in accordance with the input zip code. Accordingly, the address “Ota-ku, Tokyo” corresponding to the zip code “146-0000” is set in the text box 42a serving as an input area for an address. For the other text boxes 42c to 42e in the web page 42, the same values as those of the corresponding text boxes 41c to 41e in the web page 41 are set.

The automatic test unit 140 verifies the validity of the values set in the web page 42. In the example of FIG. 9, the values set in the web page 42 are valid, and no error is detected.

Next, processing to be performed in a case where the web app 220 is a verification target will be described. The web page 51 before the operation of operation number “1” includes five text boxes 51a to 51e. “Nakahara-ku, Kawasaki City, Kanagawa” is set in the text box 51a. “57” is set in the text box 51b. “male” is set in the text box 51c. “211” is set in the text box 51d. “0000” is set in the text box 51e.

The automatic test unit 140 performs the operation of inputting “146” to the text box 51b corresponding to the element displayed second in the web page 51 in accordance with the test case 111. The web app 220 executes processing in response to the operation of operation number “1”, and the web page to be displayed is updated to the web page 52. Among five text boxes 52a to 52e included in the web page 52 after the operation, the input value “146” is set in the text box 52b corresponding to the element displayed second in the web page.

The text box 52b is an input area for age. The value input to the text box 52b does not cause the values of the other text boxes to be updated. For this reason, for the other text boxes 52a and 52c to 52e in the web page 52, the same values as those of the corresponding text boxes 51a and 51c to 51e in the web page 51 are set.

The automatic test unit 140 verifies the validity of the value set in the web page 52. In the example of FIG. 9, the text box 52b of the web page 52 is an input area for age, and the range of value allowed to be input is “0 to 120”. In this case, the automatic test unit 140 determines that the value “146” set in the text box 52b is out of the range of settable value, and detects an error.

As described above, when the operation illustrated in the test case 111 is applied to the web app 220 as it is, “146”, which is originally the value of the first three digits of a zip code, is set in the input area for age. As a result, an error is detected.

The cause of the error illustrated in FIG. 9 is the incompatibility of a test case indicated by the test case 111. However, in behavior verification, an error is output also in a case where there is a failure in the web app 220. At this time, if it is not determined whether the cause of the error is the incompatibility of the test case 111, a user is unable to distinguish whether the cause of the error is the web app 220 or the incompatibility of a test case indicated by the test case 111.

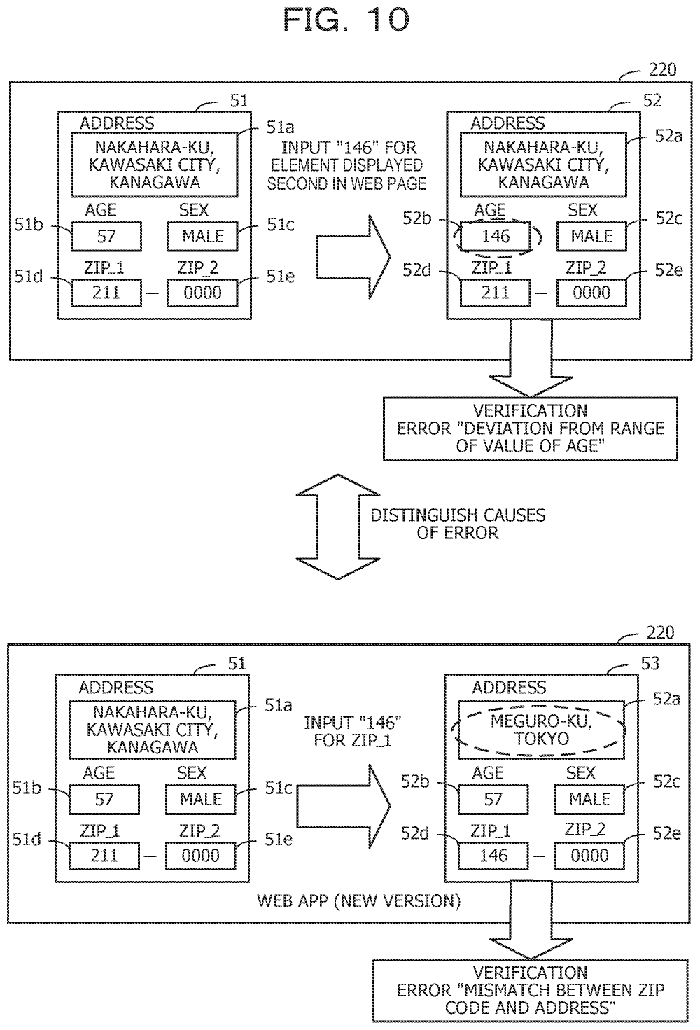

FIG. 10 is a diagram illustrating an example of two errors having different causes. In the upper part of FIG. 10, an example of a case in which an error (deviation from the range of value of age) is output due to the incompatibility of a test case is illustrated, as illustrated in FIG. 9. In the lower part of FIG. 10, an example of a case in which the test case has compatibility but the web app 220 has a failure is illustrated.

For example, in the example illustrated in the lower part of FIG. 10, the operation of inputting “146” in the text box 51d for inputting the first three digits of a zip code is performed. The web app 220 updates the address in accordance with the input zip code. In the example of FIG. 10, “Meguro-ku, Tokyo” is set in the text box 52a for address. “Ota-ku, Tokyo” is the correct address corresponding to the zip code “146-0000”. For example, the web app 220 has a failure in the function of setting an address based on a zip code. When detecting such failure, the automatic test unit 140 outputs an error indicating a mismatch between a zip code and an address.

As described above, the incompatibility of a test case may be the cause of an error detected in behavior verification, in addition to a failure in a web app. Behavior verification is performed in order to determine whether there is a failure in a web app, and it is preferable that an error caused by the incompatibility of a test case be distinguished from an error caused by a failure in a web app.

The incompatibility of a test case illustrated in FIGS. 9 and 10 occurs due to an incorrect display element of an operation target. There are various methods of designating a display element of an operation target in the test case 111.

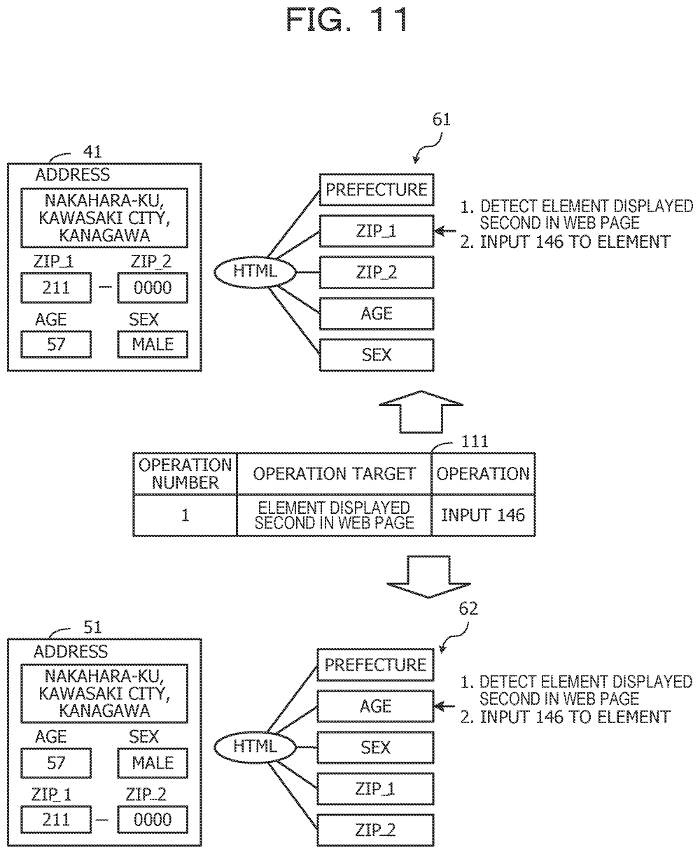

FIG. 11 is a diagram illustrating an example of a method of designating an operation target. In the example of FIG. 11, the structure of the web page 41 is represented as a tree structure 61 and the structure of the web node representing the web page 41 and a node representing the web page 51 are set as root nodes, and nodes each representing a display element are coupled to the root nodes below the root nodes. For example, such tree structure 61 and tree structure 62 may be represented by xpath.

For example, the test case generation unit 130 designates a display element of an operation target based on its position in the tree structures 61 and 62. For example, in a case where the operation target is the “element displayed second in a web page” and the details of operation is to “input 146”, for the web page 41, the display element in which the value of the first three digits of a zip code is set is detected as the operation target, and “146” is input to the display element. For the web page 51, a display element in which age is set is detected as the operation target, and “146” is input to the display element.

As described above, in a case where an operation target is designated based on its position in the tree structures 61 and 62, if the structure of the web pages 41 and 51 is changed due to modification of the web app, the same test case 111 is unable to be used in the behavior verification of the web apps 210 and 220 before and after modification.

Although FIG. 11 is an example of a case in which an operation target is designated by the tree structures 61 and 62, a similar problem occurs even when an operation target is designated by another method. For example, designating an operation target by a tag type (text, img, div, or the like), a tag ID, or the like is another method of designating an operation target. However, there is a possibility that the structure or attribute value (including the type or ID of a tag) of a page changes due to modification of the web apps 210 and 220. For this reason, it is difficult for any method of designating an operation target to completely remove incorrect display elements of operation targets in behavior verification after modification of a web app.

When an error has occurred due to the incompatibility of a test case, it means that intended operation is not performed. When operation different from the intended operation is performed, it may not be determined whether a failure has occurred in the web app 220 based on the result of the operation. Accordingly, the automatic test unit 140 first checks whether an error that has occurred is caused by the incompatibility of a test case, and if yes, displays that the incompatibility of a test case has occurred. This may reduce the work load of a user and improve the efficiency of a test.

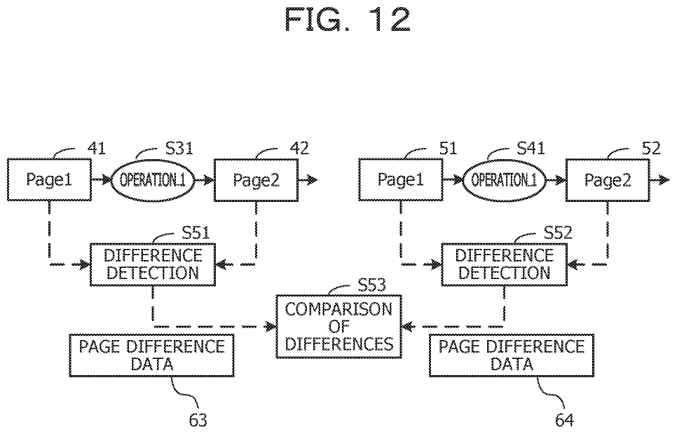

FIG. 12 is a diagram illustrating an example of a method of detecting the incompatibility of a test case. The automatic test unit 140 performs an operation for the web app 210 of an old version based on the test case 111 (step S31). The automatic test unit 140 compares the web page 41 before the operation with the web page 42 after the operation, and detects a “difference between before and after operation” (step S51). The automatic test unit 140 generates page difference data 63 corresponding to the executed operation. Information indicating the detected difference is included in the page difference data 63.

Similarly, the automatic test unit 140 performs the operation for the web app 220 of a new version based on the test case 111 (step S41). The automatic test unit 140 compares the web page 51 before the operation with the web page 52 after the operation, and detects a difference between before and after operation (step S52). The automatic test unit 140 generates page difference data 64 corresponding to the executed operation. Information indicating the detected difference is included in the page difference data 64.

Based on the page difference data 63 and the page difference data 64, the automatic test unit 140 compares the difference between before and after operation for the operation performed for the web app 210 of an old version with the difference between before and after operation for the operation performed for the web app 220 of a new version, and determines whether there is a distinction (step S53). Based on the comparison result, the automatic test unit 140 determines whether the test case is incompatible.

The page difference data 63 in the second embodiment is an example of the first difference information 7 in the first embodiment. Similarly, the page difference data 64 in the second embodiment is an example of the second difference information 8 in the first embodiment.

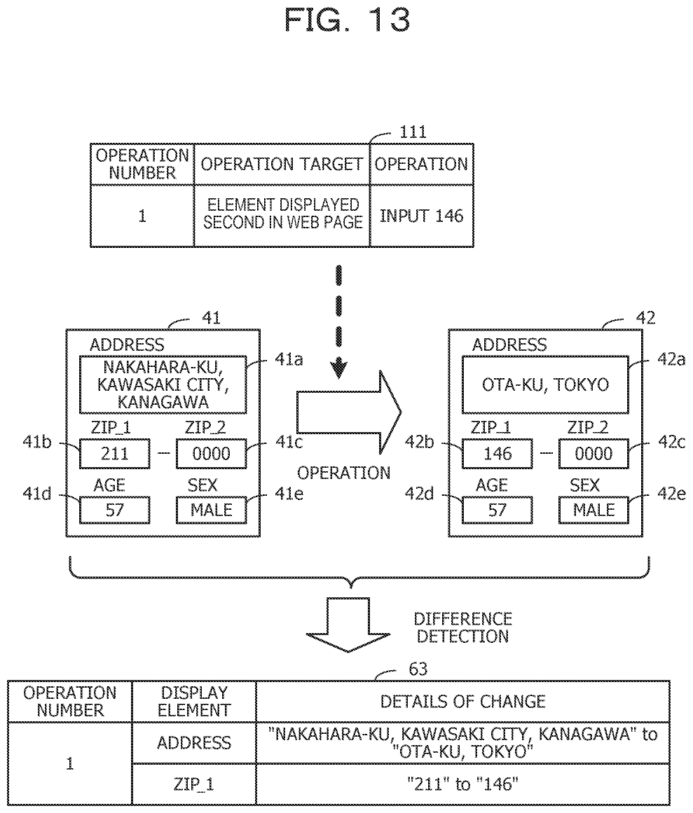

FIG. 13 is a diagram illustrating an example of page difference data. FIG. 13 illustrates the page difference data 63 indicating a difference between before and after operation for the web app 210 of an old version illustrated in FIG. 9. The operation number of the corresponding operation is set in the page difference data 63. The names of display elements having a difference in value between before and after operation are listed in the page difference data 63. In the example of FIG. 13, “address” and “zip-code_1 (ZIP_1)” are indicated as the display elements having a difference. In the page difference data 63, details of change of the value of a display element having a difference is set in association with the display element.

Such page difference data 63 is generated for each of the web app 210 of an old version and the web app 220 of a new version. Whether there is incompatibility of a test case may be determined by comparing the pieces of page difference data associated with the same operation in the old and new versions.

For example, in a case where a test case is incompatible, the details of “operation” performed for the web app 210 of an old version and the details of “operation” performed for the web app 220 of a new version are different from each other. Accordingly, a change caused by the “operation” for the web app 210 of an old version is supposed to be distinct from a change caused by the “operation” for the web app 220 of a new version. If a change that has occurred in the operation for the web app 210 of an old version has also occurred in the operation for the web app 220 of a new version in the same manner, such “operation” for the web app 210 and “operation” for the web app 220 have the same implication, and it may be determined that there is compatibility of a test case.

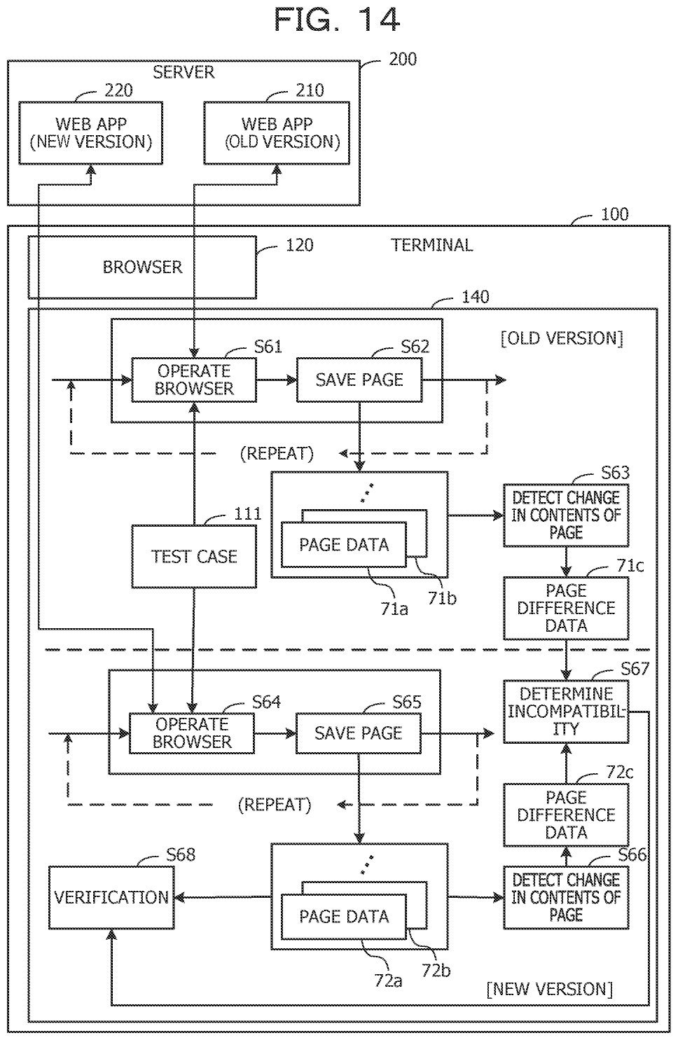

FIG. 14 is a diagram illustrating an example of the behavior verification function of the automatic test unit. First, the automatic test unit 140 performs an operation for a web page of the web app 210 of an old version via the browser 120 based on the test case 111 (step S61). Each time operation is performed, page data 71a, 71b, m indicating a web page is transmitted from the web app 210 to the automatic test unit 140. The automatic test unit 140 saves the transmitted page data 71a, 71b, . . . in the memory 102 or the storage device 103 in the acquired order (step S62).

The automatic test unit 140 compares page data with the next acquired page data among the saved page data 71a, 71b, m, and detects a change in the contents of a page (step S63). The automatic test unit 140 generates page difference data 71c indicating a difference in the contents of a page, and stores the page difference data 71c in the memory 102 or the storage device 103.

Next, the automatic test unit 140 performs an operation for a web page of the web app 220 of a new version via the browser 120 based on the test case 111 (step S64). Each time operation is performed, page data 72a, 72b, indicating a web page is transmitted from the web app 220 to the automatic test unit 140. The automatic test unit 140 saves the transmitted page data 72a, 72b, . . . in the memory 102 or the storage device 103 in the acquired order (step S65).

The automatic test unit 140 compares page data with the next acquired page data among the saved page data 72a, 72b, and detects a change in the contents of a page (step S66). The automatic test unit 140 generates page difference data 72c indicating a difference in the contents of a page, and stores the page difference data 72c in the memory 102 or the storage device 103.

The automatic test unit 140 compares the page difference data 71c for the page data acquired from the web app 210 with the page difference data 72c for the page data acquired from the web app 220. The automatic test unit 140 determines whether there is incompatibility of a test case based on the comparison result (step S67). When there is no incompatibility of a test case, the automatic test unit 140 performs behavior verification on whether there is a failure in the web app 220 based on the page data 72a, 72b, . . . acquired from the web app 220 of a new version (step S68).

As described above, behavior verification of the web app 220 is performed after checking that there is no incompatibility of a test case. Accordingly, an error that is output in the behavior verification is limited to an error caused by a failure in the web app 220, As a result, long time spent for dealing with an error caused by the incompatibility of a test case is suppressed, and the processing efficiency of behavior verification is improved.

Hereinafter, the procedure of behavior verification processing will be described in detail with reference to a flowchart.

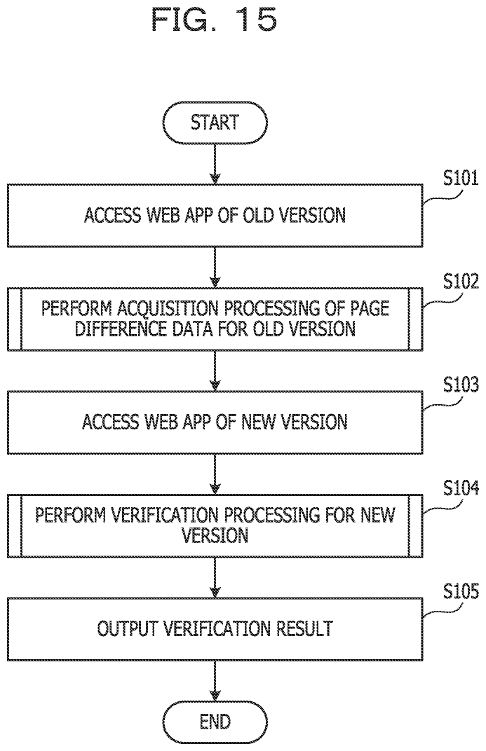

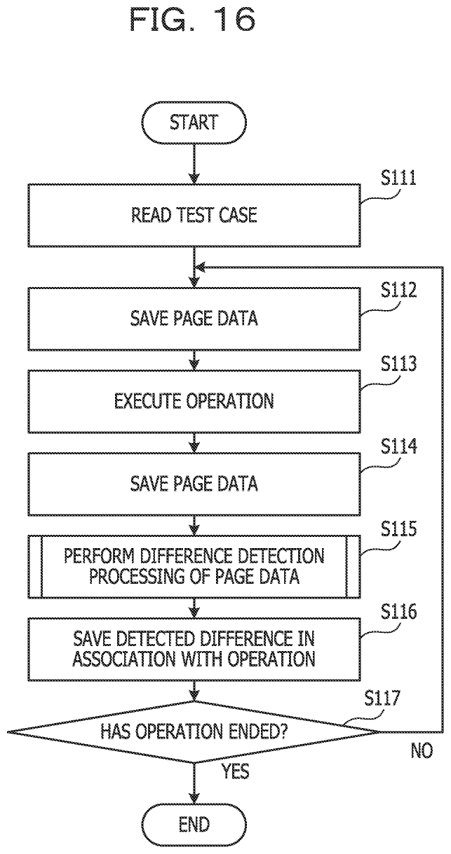

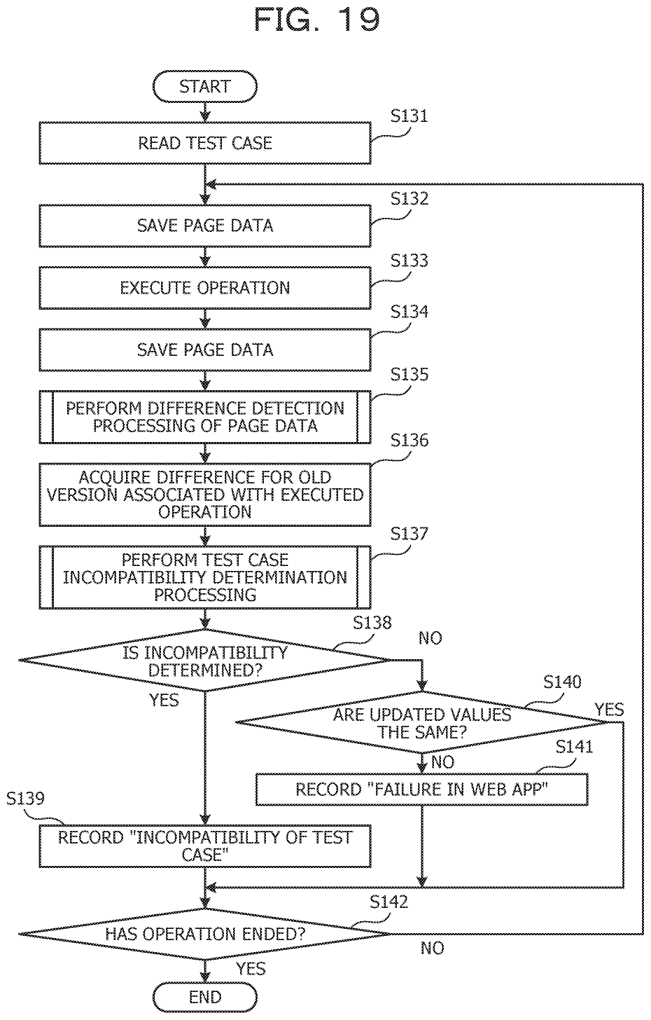

FIG. 15 is a flowchart illustrating an example of the procedure of behavior verification processing. Hereinafter, the processing illustrated in FIG. 15 will be described.

[Step S101] The automatic test unit 140 operates the browser 120 and causes the browser to access the web app 210 of an old version. For example, the automatic test unit 140 performs, for the browser 120, an operation of instructing to access the web app with a uniform resource locator (URL) corresponding to the web app 210. Accordingly, page data is transmitted from the web app 210 to the browser 120, and the browser 120 displays a web page based on the received page data.

[Step S102] The automatic test unit 140 performs acquisition processing of page difference data of the page data acquired from the web app 210 of an old version. Details of the acquisition processing will be described later (see FIG. 16).

[Step S103] The automatic test unit 140 operates the browser 120 and causes the browser to access the web app 220 of a new version. For example, the automatic test unit 140 performs, for the browser 120, an operation of instructing to access the web app with a URL corresponding to the web app 220. Accordingly, page data is transmitted from the web app 220 to the browser 120, and the browser 120 displays a web page based on the received page data.

[Step S104] The automatic test unit 140 performs verification processing for the web app 220 of a new version. Details of the verification processing will be described later (see FIG. 19).

[Step S105] The automatic test unit 140 outputs the verification result.

As described above, behavior verification of the web app 220 of a new version is performed.

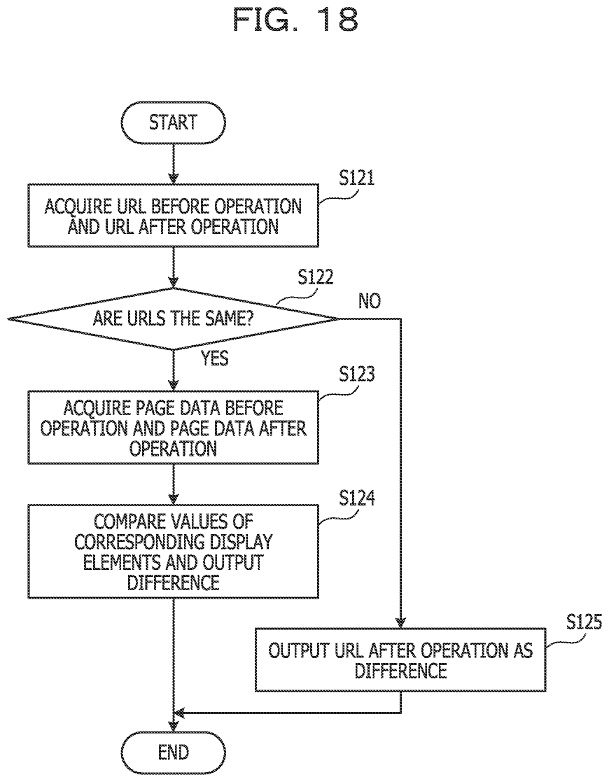

FIG. 16 is a flowchart illustrating an example of the procedure of acquisition processing of page difference data for an old version. Hereinafter, the processing illustrated in FIG. 16 will be described.

[Step S111] The automatic test unit 140 reads the test case 111 from the storage unit 110.

[Step S112] The automatic test unit 140 saves page data of a web page displayed on the browser 120 in the memory 102 or the storage device 103.

[Step S113] The automatic test unit 140 acquires details of operation for an unprocessed operation that comes up next from the test case 111, and executes the operation indicated in the details of operation for the browser 120. The browser 120 transmits information corresponding to the operation to the web app 210. The web app 210 transmits page data indicating the updated web page to the browser 120, The browser 120 updates the displayed web page based on the received page data.

[Step S114] The automatic test unit 140 saves the page data of the web page displayed by the browser 120 in the memory 102 or the storage device 103 in association with the URL of the web page as the access destination.

[Step S115] The automatic test unit 140 performs difference detection processing of page data before operation and page data after operation. Details of the difference detection processing will be described later (see FIG. 18).

[Step S116] The automatic test unit 140 saves the detected difference in association with the operation executed in step S113. For example, the automatic test unit 140 saves the page difference data 71c corresponding to the executed operation in the memory 102 or the storage device 103.

[Step S117] The automatic test unit 140 determines whether the entire operation indicated in the test case 111 has ended. After the entire operation has ended, the automatic test unit 140 ends the acquisition processing of page difference data for an old version. In a case where there is an unprocessed operation, the automatic test unit 140 causes the processing to proceed to step S112.

As described above, page difference data indicating a difference between page data before operation and page data after operation may be accumulated in a case where an operation is performed for the web app 210 of an old version. The format of the page data to be saved is HTML, a Document Object Model (DOM), a screen image, or the like. For example, the automatic test unit 140 may acquire DOM information indicating the tree structure of page data by using the DOM information extraction function of the browser 120.

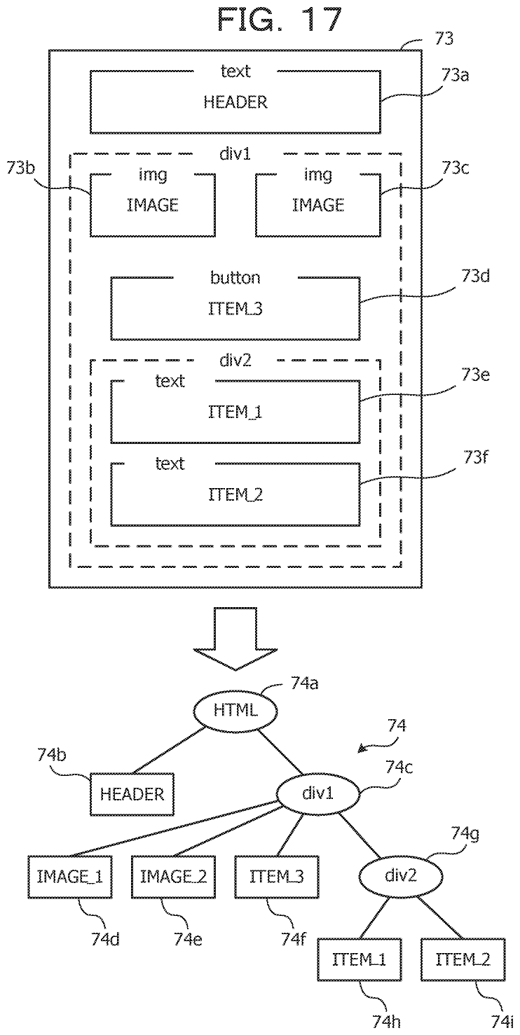

FIG. 17 is a diagram illustrating an example of page data saving processing. For example, a web page 73 is written in HTML, The web page 73 includes six elements of 73a to 73f. The element 73a is a header. The element 73a is a non-display element.

The other elements 73b to 73f are grouped by a tag “div1”, The elements 73b and 73c are image data. The element 73d is a button. The elements 73e and 73f are grouped by a tag “div2”, Both the elements 73e and 73f are text data. The elements 73b to 73f are display elements.

Page data 74 of such web page 73 has a tree structure, in which the relationship among the elements 73a to 73f is represented by the coupling relationship among a plurality of nodes 74a to 74i. The node 74a is a root node, and indicates that the web page 73 is written in HTML, The nodes 74b and 74c are coupled to the node 74a below the node 74a. The node 74b is a leaf node corresponding to the header element 73a. The node 74c is a node corresponding to the tag “div1”.

The nodes 74d to 74g are coupled to the node 74c below the node 74c. The nodes 74d to 74f are leaf nodes that correspond to the elements 73b to 73d, respectively. The node 74g is a node corresponding to the tag “div2”. The nodes 74h and 74i are coupled to the node 74g below the node 74g. The nodes 74h and 74i are leaf nodes that correspond to the elements 73e and 73f, respectively.

The automatic test unit 140 performs difference detection processing of page data by using such page data 74 having a tree structure. For example, the automatic test unit 140 compares the display elements at the same position in a tree structure, and determines whether there is a difference between the display elements,

FIG. 18 is a flowchart illustrating an example of the procedure of difference detection processing of page data. Hereinafter, the processing illustrated in FIG. 18 will be described.

[Step S121] The automatic test unit 140 acquires the URL of page data before operation and the URL of page data after operation.

[Step S122] The automatic test unit 140 determines whether the acquired URLs are the same. If the URLs are the same, the automatic test unit 140 causes the processing to proceed to step S123, If the URLs are different, the automatic test unit 140 causes the processing to proceed to step S125.

[Step S123] The automatic test unit 140 acquires page data before operation and page data after operation.

[Step S124] The automatic test unit 140 compares the values of corresponding display elements (for example, display elements at the same position in a tree structure), and outputs a difference. After that, the automatic test unit 140 ends the processing.

[Step S125] The automatic test unit 140 outputs the URL afters operation as a difference.

As described above, the automatic test unit 140 compares pieces of page data only when the URL before operation and the URL after operation are the same. Accordingly, comparison between pieces of page data with different URLs may be avoided, and useless processing may be suppressed.

After page difference data is saved, the automatic test unit 140 causes the browser 120 to access the web app 220 of a new version, and performs verification processing of the web app.

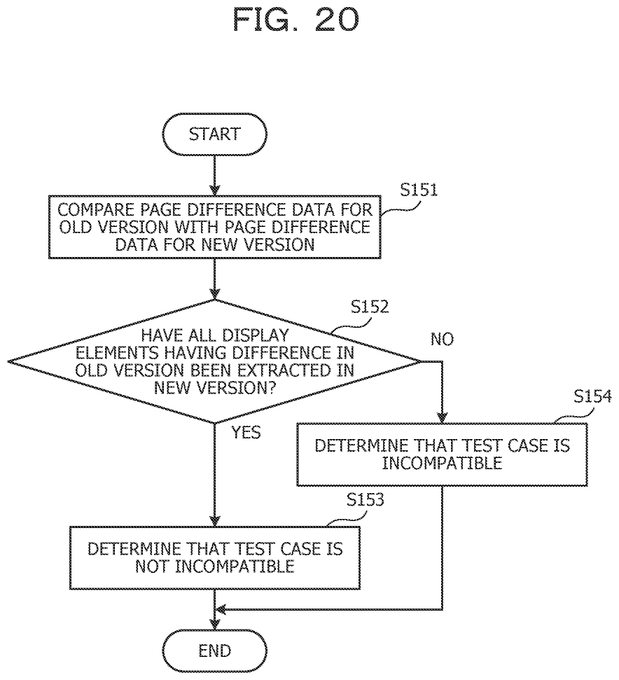

FIG. 19 is a flowchart illustrating an example of the procedure of verification processing for a new version. Hereinafter, the processing illustrated in FIG. 19 will be described.

[Step S131] The automatic test unit 140 reads the test case 111 from the storage unit 110.

[Step S132] The automatic test unit 140 saves page data of a web page displayed on the browser 120 in the memory 102 or the storage device 103.

[Step S133] The automatic test unit 140 acquires details of operation for an unprocessed operation that comes up next from the test case 111, and executes the operation indicated in the details of operation for the browser 120. The browser 120 transmits information corresponding to the operation to the web app 220. The web app 220 transmits page data indicating the updated web page to the browser 120. The browser 120 updates the displayed web page based on the received page data.

[Step S134] The automatic test unit 140 saves the page data of the web page displayed by the browser 120 in the memory 102 or the storage device 103 in association with the URL of the web page as the access destination.

[Step S135] The automatic test unit 140 performs difference detection processing of page data before operation and page data after operation. Details of the difference detection processing are similar to those of the processing described with reference to FIG. 18.

[Step S136] The automatic test unit 140 acquires page difference data for the old version associated with the executed operation.

[Step S137] The automatic test unit 140 performs test case incompatibility determination processing. Details of the test case incompatibility determination processing will be described later (see FIG. 20), The page difference data for the old version is compared with page difference data for the new version.

[Step S138] The automatic test unit 140 determines whether the incompatibility of a test case is determined. When the incompatibility is determined, the automatic test unit 140 causes the processing to proceed to step S139. When the incompatibility is not determined, the automatic test unit 140 causes the processing to proceed to step S140.

[Step S139] The automatic test unit 140 records in the memory 102 that the incompatibility of a test case has occurred with respect to the executed operation. After that, the automatic test unit 140 causes the processing to proceed to step S142.

[Step S140] The automatic test unit 140 determines whether the updated values in the page difference data for the old and new versions are the same. When the values are the same, the automatic test unit 140 causes the processing to proceed to step S142. When the values are not the same, the automatic test unit 140 causes the processing to proceed to step S141.

[Step S141] The automatic test unit 140 records in the memory 102 that a failure has been detected in the web app with respect to the executed operation.

[Step S142] The automatic test unit 140 determines whether the entire operation indicated in the test case 111 has ended. After the entire operation has ended, the automatic test unit 140 ends the verification processing for a new version. In a case where there is an unprocessed operation, the automatic test unit 140 causes the processing to proceed to step S132.

As described above, each time the operation indicated in the test case 111 is executed, whether there is incompatibility of a test case is determined for the operation. If there is no incompatibility, whether there is a failure in a web app is determined. Accordingly, it is determined whether an error that has occurred in behavior verification is caused by the incompatibility of a test case or a failure in a web app.

Next, details of the test case incompatibility determination processing will be described.

FIG. 20 is a flowchart illustrating an example of the procedure of the test case incompatibility determination processing, Hereinafter, the processing illustrated in FIG. 20 will be described.

[Step S151] The automatic test unit 140 compares the page difference data for an old version with the page difference data for a new version.

[Step S152] The automatic test unit 140 determines whether all display elements having a difference in the old version have been extracted in the new version as having a difference. If all the corresponding display elements have been extracted in the new version, the automatic test unit 140 causes the processing to proceed to step S153. In a case where at least some of the display elements extracted in the old version have not been extracted in the new version, the automatic test unit 140 causes the processing to proceed to step S154.

[Step S153] The automatic test unit 140 determines that there is no incompatibility of a test case with respect to the executed operation, and ends the test case incompatibility determination processing.

[Step S154] The automatic test unit 140 determines that a test case is incompatible with respect to the executed operation, and ends the test case incompatibility determination processing.

As described above, whether there is incompatibility of a test case is determined. For example, when the same operation is performed for the web app 210 of an old version and the web app 220 of a new version, if the web pages change in the same manner, it is determined that there is no incompatibility of a test case.

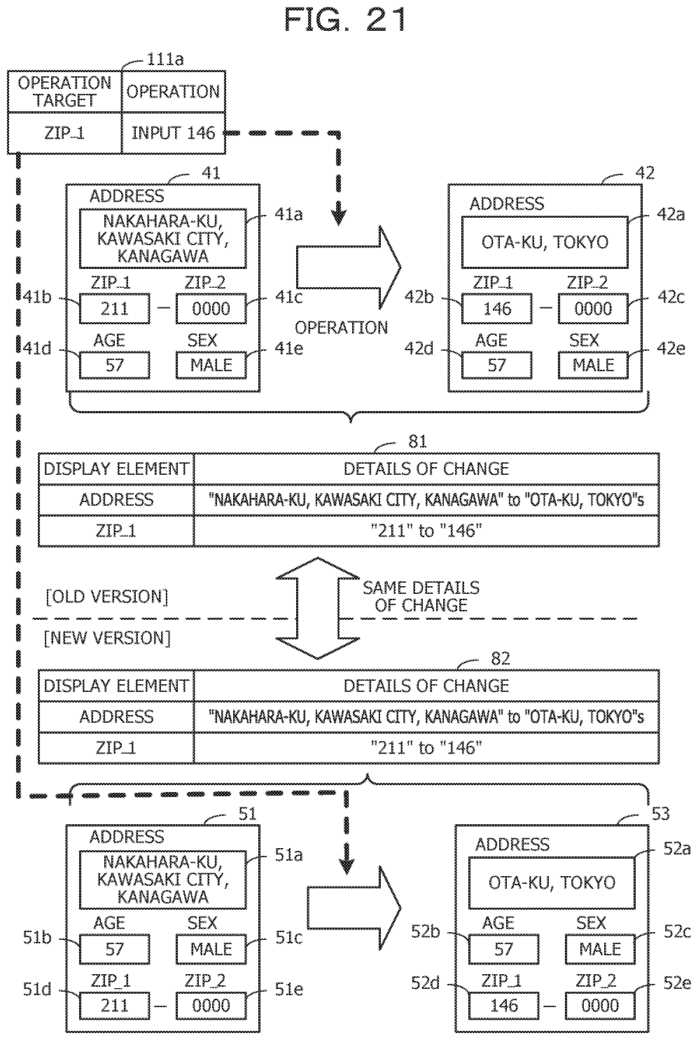

Hereinafter, with reference to FIGS. 21 to 23, an example of determining whether there is incompatibility of a test case or whether there is a failure in a web app will be described.

FIG. 21 is a diagram illustrating an example of a case in which neither the incompatibility of a test case nor a failure in a web app is detected. In the example of FIG. 21, in a test case 111a, the operation target is designated by the name “ZIP_1” given to a display element, and the operation of inputting “146” is indicated.

In the web app 210 of an old version, the text box 41b in the web page 41 before operation is the operation target, By performing the operation of inputting “146” to the text box 41b, the values of the text box 42a for address and the text box 42b for inputting the first three digits of a zip code are changed in the web page 42 after operation. Accordingly, the details of change for the display element “address” and the details of change for the display element “ZIP_1” are set in page difference data 81 for the web app 210 of an old version.

In the web app 220 of a new version, the text box 51d in the web inputting “146” to the text box 51d, the values of the text box 52a for address and the text box 52d for inputting the first three digits of a zip code are changed in the web page 52 after operation. Accordingly, the details of change for the display element “address” and the details of change for the display element “ZIP_1” are set in page difference data 82 for the web app 220 of a new version.

The page difference data 81 for the web app 210 of an old version and the page difference data 82 for the web app 220 of a new version include the same display elements extracted as having a difference. For this reason, it is determined that the test case 111a is not incompatible. The page difference data 81 and the page difference data 82 also include the same details of change for the display elements extracted in common. Accordingly, it is also determined that a failure has not occurred in the web app,

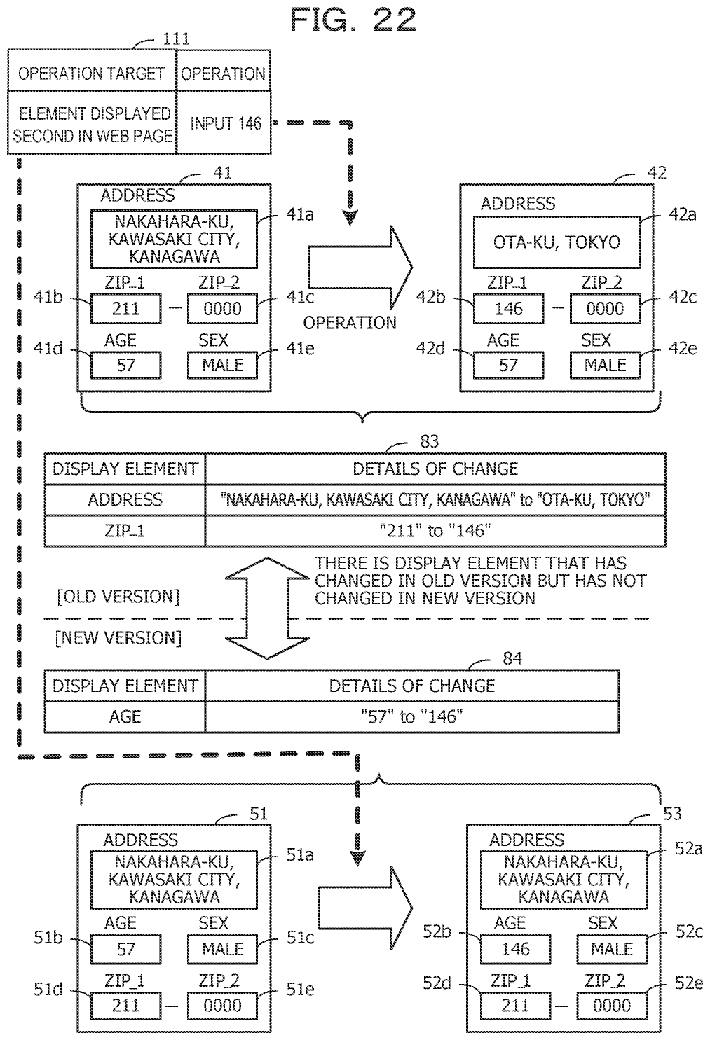

FIG. 22 is a diagram illustrating an example of a case in which the incompatibility of a test case is detected. In the example of FIG. 22, in the test case 111, the operation target is designated by the position of the display element in a tree structure “element displayed second in a web page”, and the operation of inputting “146” is indicated.

The values of display elements in the web page 41 before operation and the web page 42 after operation for the web app 210 of an old version are the same as those in the example illustrated in FIG. 21. For this reason, the contents of page difference data 83 to be generated are the same as those of the page difference data 81 illustrated in FIG. 21.

In the web app 220 of a new version, the text box 51b in the web page 51 before operation is the operation target. By performing the operation of inputting “146” to the text box 51b, the value of the text box 52b for age is changed in the web page 52 after operation. Accordingly, the details of change for the display element “age” is set in page difference data 84 for the web app 220 of a new version.

The page difference data 83 for the web app 210 of an old version and the page difference data 84 for the web app 220 of a new version include distinct display elements extracted as having a difference. For example, the display element “address” indicated as having a difference in the page difference data 83 is not included in the page difference data 84. For example, there is a display element that is changed by the operation for the web app 210 of an old version but is not changed by the operation for the web app 220 of a new version. This means that the same processing is not executed in the web app 210 of an old version and the web app 220 of a new version in response to the operation with the same operation number. For this reason, it is determined that the test case 111a is incompatible. In a case where the test case is incompatible, behavior verification of the web app 220 is unable to be correctly performed by using the test case 111a. For this reason, detection of a failure in a web app is not performed.

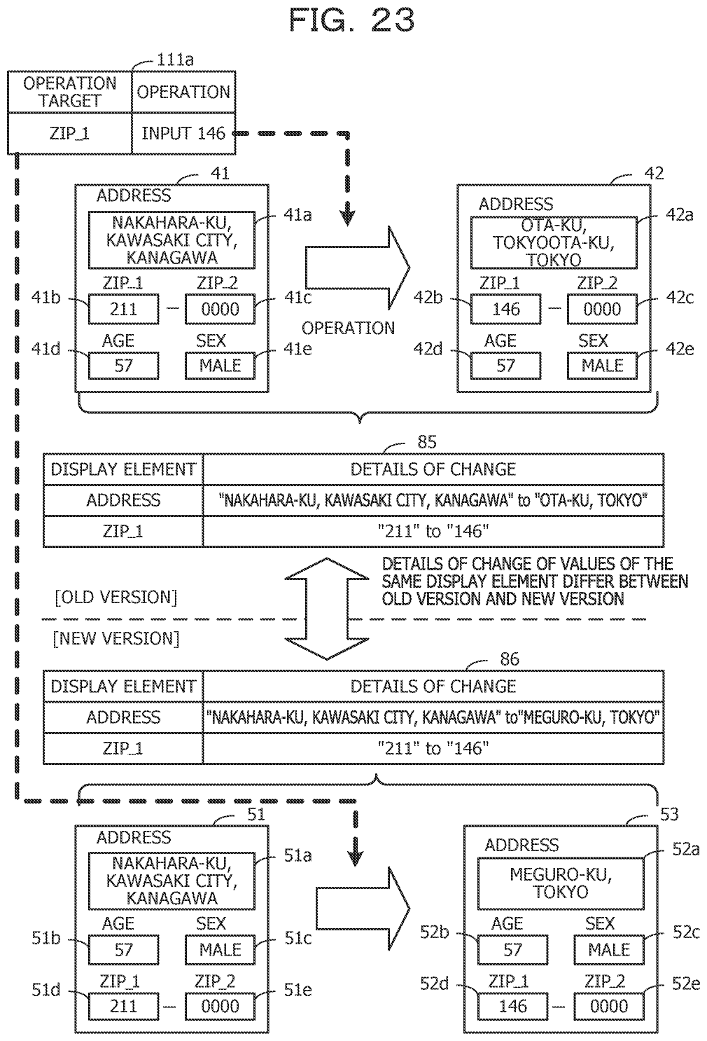

FIG. 23 is a diagram illustrating an example of a case in which a failure is detected in a web app. In the example of FIG. 23, in the test case 111a, the operation target is designated by the name “ZIP_1” given to a display element, and the operation of inputting “146” is indicated.

The values of display elements in the web page 41 before operation and the web page 42 after operation for the web app 210 of an old version are the same as those in the example illustrated in FIG. 21. For this reason, the contents of page difference data 85 to be generated are the same as those of the page difference data 81 illustrated in FIG. 21.

In the web app 220 of a new version, the text box 51d in the web page 51 before operation is the operation target, By performing the operation of inputting “146” to the text box 51d, the values of the text box 52a for address and the text box 52d for inputting the first three digits of a zip code are changed in the web page 52 after operation. Accordingly, the details of change for the display element “address” and the details of change for the display element “ZIP_1” are set in page difference data 86 for the web app 220 of a new version.

The page difference data 85 for the web app 210 of an old version and the page difference data 86 for the web app 220 of a new version include the same display elements extracted as having a difference. For this reason, it is determined that the test case 111a is not incompatible. However, the page difference data 85 and the page difference data 86 include distinct details of change for the display element extracted in common. For example, the value of the display element “address” is changed to “Ota-ku, Tokyo” in the web app 210 of an old version, while the value of the display element “address” is changed to “Meguro-ku, Tokyo” in the web app 220 of a new version. For this reason, it is determined that there is a failure in the web app 220.

By comparing the page difference data 81, 83, and 85 for the web app 210 with the page difference data 82, 84, and 86 for the web app 220, respectively, in this manner, the incompatibility of the test cases 111 and 111a may be distinguished from a failure in the web app 220. As a result, the place of occurrence of an error may be efficiently identified in the behavior verification of the web app 220 after modification.

### OTHER EMBODIMENTS

Although behavior verification of a web app is performed in the second embodiment, behavior verification processing may be applied similarly to an app using a GUI other than a web app. Without being limited to an app, behavior verification processing may be applied similarly to software such as an OS or middleware.

Although operation for a web app is performed via a browser in the second embodiment, in a case where behavior verification target is an app using a GUI other than a web app, the test case generation unit 130 or the automatic test unit 140 may directly operate the screen of the app of a verification target.

Although the embodiments are exemplified above, the configuration of each unit described in the embodiment may be replaced with another one having a similar function. Other arbitrary components or steps may be added. Two or more arbitrary configurations (features) of the above-described embodiments may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
acquiring first difference information that indicates a difference between display elements included in a first screen of first software before a test operation indicated by a test case is performed for the first screen and display elements included in a second screen of the first software after the test operation is performed for the first screen;
acquiring second difference information that indicates a difference between display elements included in a third screen of second software before the test operation is performed for the third screen and display elements included in a fourth screen of the second software after the test operation is performed for the third screen, the second software being generated by updating the first software; and
determining whether there is compatibility of the test case between the first software and the second software based on the first difference information and the second difference information.

2. The non-transitory computer-readable recording medium according to claim 1, wherein
the first difference information indicates first display elements whose values change when the first screen transitions to the second screen,
the second difference information indicates second display elements whose values change when the third screen transitions to the fourth screen, and
the process further comprises:
determining that there is no compatibility of the test case when corresponding one of the second display elements does not exist for at least one of the first display elements.

3. The non-transitory computer-readable recording medium according to claim 2, the process further comprising:
determining that there is compatibility of the test case when the first display elements respectively correspond to the second display elements; and
determining whether there is a failure in the second software upon determining that there is compatibility of the test case.

4. The non-transitory computer-readable recording medium according to claim 3, wherein
the first difference information includes changed values of the first display elements,
the second difference information includes changed values of the second display elements, and
the process further comprises:
determining whether there is a failure in the second software based on a result of comparison between the changed values of the first display elements and the changed values of the second display elements respectively corresponding to the first display elements.

5. A test support method, comprising:
acquiring, by a computer, first difference information that indicates a difference between display elements included in a first screen of first software before a test operation indicated by a test case is performed for the first screen and display elements included in a second screen of the first software after the test operation is performed for the first screen;
acquiring second difference information that indicates a difference between display elements included in a third screen of second software before the test operation is performed for the third screen and display elements included in a fourth screen of the second software after the test operation is performed for the third screen, the second software being generated by updating the first software; and
determining whether there is compatibility of the test case between the first software and the second software based on the first difference information and the second difference information.

6. An information processing apparatus, comprising:
a memory; and
a processor coupled to the memory and the processor configured to:
acquire first difference information that indicates a difference between display elements included in a first screen of first software before a test operation indicated by a test case is performed for the first screen and display elements included in a second screen of the first software after the test operation is performed for the first screen;
acquire second difference information that indicates a difference between display elements included in a third screen of second software before the test operation is performed for the third screen and display elements included in a fourth screen of the second software after the test operation is performed for the third screen, the second software being generated by updating the first software; and
determine whether there is compatibility of the test case between the first software and the second software based on the first difference information and the second difference information.
